(19) United States
(12) Patent Application Publication
(10) Pub. No.: US 2003/0131582 A1
(43) Pub. Date: Jul. 17, 2003

(54) Coal and syngas fueled power generation systems featuring zero atmospheric emissions

(76) Inventors: Roger E. Anderson, Gold River, CA (US); Harry Brandt, El Macero, CA (US); Fermin Viteri, Sacramento, CA (US)

Correspondence Address: Bradley P. Heisler, Heisler & Associates, Suite 300, 3017 Douglas Blvd., Roseville, CA, 95661, US

(21) Appl. No.: 10/304,290

(22) Filed: Nov. 25, 2002

Related U.S. Application Data
(60) Provisional application No. 60/336,648, filed on Dec. 3, 2001.
(60) Provisional application No. 60/336,649, filed on Dec. 3, 2001.
(60) Provisional application No. 60/336,653, filed on Dec. 3, 2001.
(60) Provisional application No. 60/336,673, filed on Dec. 3, 2001.

(51) Int. Cl. F02C 3/28

(52) U.S. Cl. 60/39.55

(57) ABSTRACT

A coal syngas or other syngas fired power plant is provided with no atmospheric emissions. Coal or other starter fuel is gasified within a gasifier which also receives oxygen and steam therein. The oxygen is provided from an air separator. Syngas produced within the gasifier is combusted within a gas generator along with oxygen from the air separator. Water is also introduced into the gas generator to control the temperature of combustion of the syngas with the oxygen. Products of combustion including steam and carbon dioxide are produced within the gas generator. The combustion products are expanded through a turbine for power output and then separated, such as within a condenser. Water discharged from the condenser is at least partially recirculated back to the gasifier and the gas generator. Carbon dioxide from the separator is compressed for capture without release into the atmosphere.

### CROSS-REFERENCE TO RELATED APPLICATIONS

This application claims benefit under Title 35, United States Code §119(e) of U.S. Provisional Application Nos. 60/336,648, 60/336,649, 60/336,653 and 60/336,673 filed on Dec. 3, 2001. This application also incorporates by reference the entire contents of U.S. Pat. Nos. 5,709,077, 6,206,684, 6,247,316 and U.S. patent application Ser. No. 09/855,237, having a filing date of May 14, 2001 and U.S. patent application Ser. No. 10/155,932, having a filing date of May 24, 2002.

### BACKGROUND OF THE INVENTION

Currently and for the near future, coal provides a substantial portion of the world's supply of electric energy. Pollution from coal-fired power plants is a pressing environmental problem and the emission of carbon dioxide is of increasing concern in regard to global warming.

Coal is a desirable fuel for electric power generation especially if power plants are designed to give zero atmospheric emissions. The world has an abundant supply of energy in coal. In 1996, coal provided approximately 24% of the world's total energy supply and 38.4% of the world's electricity generation. In comparison, in 1999 the electricity production in the United States was 10.1 ExaWh (10.1×1018 Wh), while electricity production from coal was 5.67 ExaWh, or 56% of the total electricity production. The United States has 507.8 billion metric ton of demonstrated coal reserves while the consumption in the year 2000 was 1.097 billion metric tons. Hence, the United States has a coal supply of more than 460 years based on today's consumption. With a 1.5% annual growth in energy use, the United States still would have more than 100 years of energy supply in coal. Coal is expected to remain a long-term candidate for electric energy production both in the United States and in the world. Coal and other heavy liquid/solid fuels require preprocessing prior to combustion in the gas generator. The preprocessing of these fuels involves conversion to syngas in oxygen-blown gasifiers and subsequent cleansing of particulates (ash and carbon), sulfur compounds (H2S and COS), and some of the other impurities (e.g., nitrogen, chlorine, volatile metals) prior to introduction into the gas generator. Although gasification and gas cleanup moderately increase plant capital costs, this technology is well established and currently is practiced on a large scale. Oxygen is used to combust the fuel rather than air as in conventional systems thereby eliminating the formation of NOx and the large volume of noncondensible exhaust gas. The oxygen is obtained from air via a number of processes, including commercially available cryogenic air separation units (ASU). Advanced air separation technologies such as those based on ion transfer membranes (ITM) hold promise for lowering the cost of oxygen and therefore are expected to enhance the economics of future oxygen using power generation systems.

### SUMMARY OF THE INVENTION

The invention starts with oxygen blown gasification of coal. The resulting gaseous syngas is cleaned of corrosive components and burned with oxygen in the presence of recycled water in a gas generator. The combustion produces a drive gas composed almost entirely of steam and carbon dioxide. This gas drives multiple turbines/electric generators to produce electricity. The turbine discharge gases pass to a condenser where water is captured as liquid and gaseous carbon dioxide is pumped from the system. The carbon dioxide can be economically conditioned for enhanced recovery of oil or coal bed methane, or for sequestration in a subterranean formation.

### OBJECTS OF THE INVENTION

Accordingly, a primary object of the present invention is to provide a power generation system which combusts a syngas produced from gasification of coal, biomass, or other fuel sources with oxygen to produce combustion products including carbon dioxide and water and to generate power without atmospheric emissions.

Another object of the present invention is to provide a power generation system which combusts a syngas fuel, such as coal syngas, with oxygen to produce power and which collects carbon dioxide in a form which can be sold as a byproduct or sequestered out of the atmosphere.

Another object of the present invention is to generate power from combustion of a hydrocarbon fuel with high efficiency and without any atmospheric emissions.

Other further objects of the present invention will become apparent from a careful reading of the included drawing figures, the claims and detailed description of the invention.

### BRIEF DESCRIPTION OF THE DRAWINGS

FIG. 1 is a schematic of the basic zero-emissions power generation system of this invention.

FIG. 2 includes schematic diagrams of a gas generator for combustion of syngas with oxygen for use in the power generation systems of this invention.

FIG. 3 is a schematic of a four hundred megawatt electric power generating plant operating on coal syngas and with zero atmospheric emissions with sets of three numbers at various locations throughout the power plant representative of pressure (top number in MPa), temperature (middle number in K) and weight flow (bottom number in kg per second).

FIG. 4 is a detailed schematic of a power generation system which is a variation on that which is shown in FIG. 3.

FIG. 5 is a power plant schematic for an integrated gasification combined cycle power plant fired with syngas and oxygen.

FIG. 6 is a schematic diagram of that which is shown in FIG. 5 and including supplementary heating.

FIG. 7 is a power plant schematic similar to that which is shown in FIG. 5, but additionally illustrating the inclusion of condensers and steam injection into a combustor of the power generation system depicted therein.

FIG. 8 is a schematic diagram of a power plant similar to that which is shown in FIG. 6, but additionally including the location of condensers and incorporating steam injection into a combustor of the power plant.

FIG. 9 is a schematic of an open cycle integrated gasification combined cycle power plant fired with syngas, illustrative of power plants known in the prior art.

FIG. 10 is a power plant schematic similar to that which is shown in FIG. 9 but with the inclusion of a carbon dioxide recovery system.

FIG. 11 is a power plant schematic featuring a base load steam turbine and a peak load steam turbine, along with a methanol reactor, distinguishing the system from the system shown in FIGS. 3 and 4.

FIG. 12 is a detailed schematic of a syngas powered power generation system similar to that which is shown in FIGS. 3 and 4, with the additional inclusion of hydrogen separation and fuel cells for additional electric power generation.

### DESCRIPTION OF THE PREFERRED EMBODIMENT

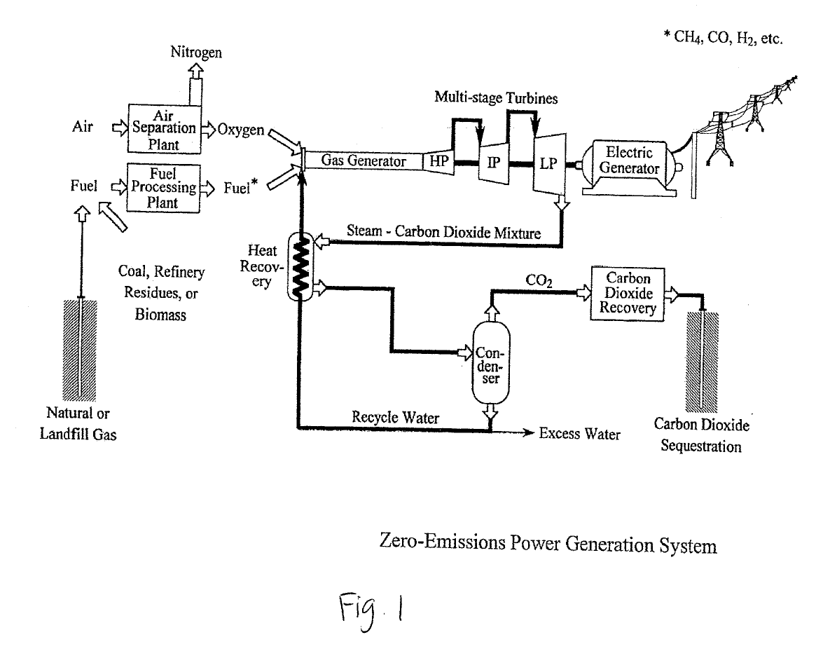

A simplified schematic diagram of the basic process of the various embodiments of this invention is shown in FIG. 1. The use of coal in this system requires the conversion of coal to syngas by means of established oxygen-blown gasification and syngas cleanup processes. Oxygen is obtained from air in an air separation plant. The syngas, oxygen and water from the plant are delivered to a gas generator where combustion takes place. The syngas is combusted with oxygen in a gas generator while water is injected into the gas generator to control the temperature of the combustion products. The mixture of combustion products and cooling water form the drive gas for the turbines. This mixture, consists primarily of steam (H2O) and carbon dioxide (CO2). The combustion products of the gas generator preferably drive (i.e. are expanded into) multiple turbines, including a high-pressure turbine (HP), typically followed by an intermediate-pressure turbine (IP) and a low-pressure turbine (LP). The three turbines drive an electric generator. The turbine drive gas leaving the low-pressure turbine passes through a feed water heat recovery unit to a condenser where the carbon dioxide separates from the condensing steam.

Most of the water from the condenser is heated and returned to the gas generator to reduce the temperature of the combustion products in the gas generator to a temperature that is acceptable to the turbines. Excess water resulting from the combustion process is removed from the system.

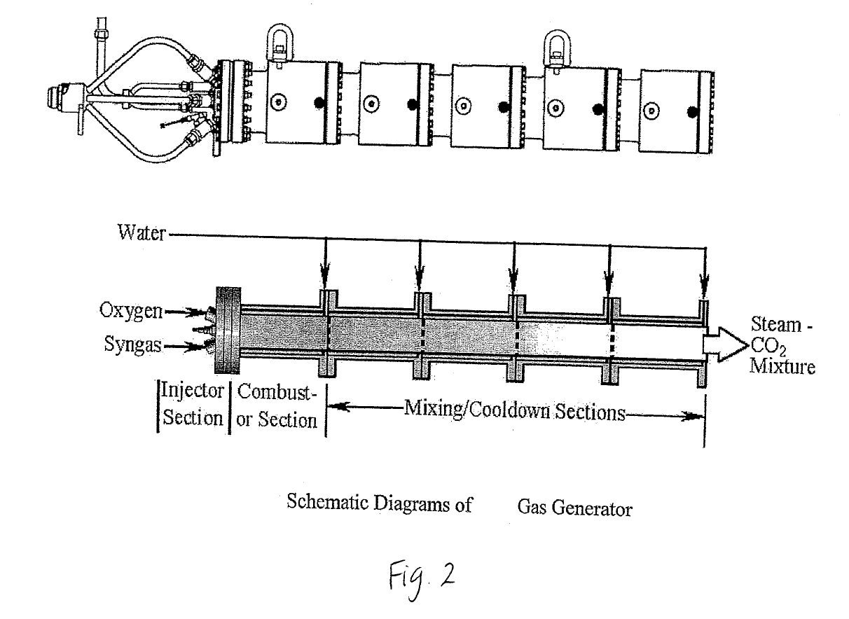

Gaseous CO2 leaving the condenser passes to a recovery system. Residual moisture is removed from the CO2 in the recovery system where it is also cooled and compressed to conditions necessary either for sequestration into a subterranean formation, or for further use. For example, the CO2 can be used in enhanced oil recovery operations, injected into coal seams to recover coal bed methane, or processed into saleable products if local markets exist. With this process, atmospheric emissions of controlled pollutants and greenhouse gases are totally eliminated. The gas generator shown in FIG. 2 and described in patents listed above and incorporated herein by reference, enable the zero atmospheric emissions power systems of this invention.

The gas generator consists of an injector section, a combustor section, and a number of cooldown sections. These sections embody several aerospace derived design features to control mixture ratios, gas temperatures, gas pressures, and combustion reaction times. For instance, bonded photo-etched platelet designs are utilized to accomplish metering, mixing, and cooling functions. The injector can optionally premix the gaseous reactants (syngas and oxygen) with recycled water from the plant in precise ratios and incorporate an integral face-cooling feature. The combustor section and the cooldown sections are regeneratively cooled with recycled water. The amount of water injected into the combustor and into each cooldown section is controlled to produce specific combustion temperatures. Temperatures and residence times in those sections are selected based on reaction kinetics so that daughter species produced in the combustion process have time to recombine.

For a 400 MWe (Mega Watt electrical output) plant, three gas generators, each with a thermal output of 400 MWt (Mega Watt thermal output), would be used. The three gas generators would be installed in parallel. Two of the gas generators would drive the turbines of the plant while the third gas generator would provide a spare during service of the other units. A gas generator with 400 MWt thermal output operating at a pressure of 10.3 MPa has an internal diameter of 0.46 m and a length of 1.88 m.

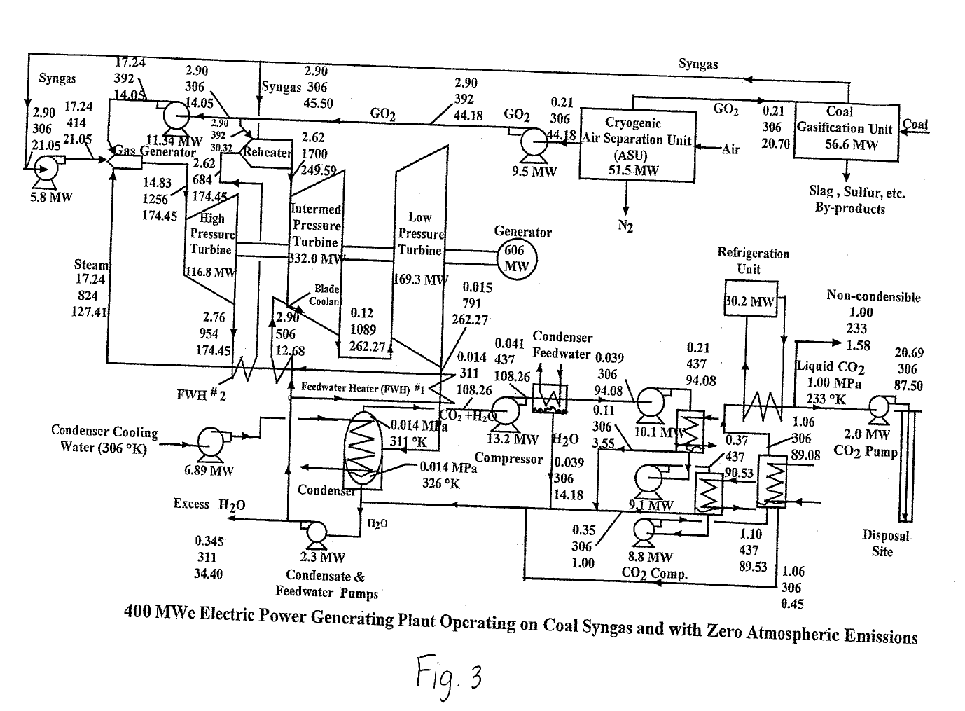

FIG. 3 is a schematic diagram of a typical 400 MWe power plant using advanced turbine technology. The figure identifies major plant components and their power consumption. The plant efficiency is 55% based on the lower heating value of the coal and includes: 1) the syngas plant power consumption, 2) the power to the cryogenic air separation plant, and 3) the power to compress the CO2 to 20.7 MPa for sequestration.

In FIG. 3, the plant operating conditions are listed at various locations in the plant in terms of groups of three numbers; the top number is the local pressure in MPa, the middle number is the local temperature in K, and the bottom number is the weight flow in kg/sec.

A gasifier converts coal to syngas at a rate of 66.55 kg/sec, while a 51.5 MWe cryogenic air separation plant produces oxygen for both the gasifier and the gas generator. Two gas streams (syngas and oxygen) enter the gas generator at a pressure of 17.24 MPa where they are joined by 139.35 kg/sec of steam.

The syngas from the gasification plant is combusted with oxygen in the gas generator. The combustion products are cooled in steps by adding water until the gas temperature is at the allowable high-temperature turbine inlet temperature of 922 K to 1256 K. The turbine drive gas leaving the high pressure turbine is preferably reheated by a reheater before it enters the intermediate-pressure turbine.

The intermediate-pressure turbine exhaust gases are delivered to the low pressure turbine. The exhaust from the low-pressure turbine is cooled in a feed water heater to the desired condenser inlet temperature. The heated feed water is delivered to the gas generator for use as a coolant to reduce the temperature of the turbine drive gas as described above.

The turbine exhaust gases which, by weight, contain approximately 66.2% steam, 33.3% CO2 and 0.45% nitrogen, oxygen and other non-condensables are cooled in the condenser with 306 K cooling water. In the condenser, the steam condenses at approximately 311 K and at 0.014 MPa. There is still moisture in the CO2 stream that does not separate without compression and further cooling.

The mixture of approximately 75% CO2 and 25% steam, by weight, is then pumped from the condenser using centrifugal compressors and is cooled in stages to remove the remaining water prior to liquefying the dry CO2 in a refrigeration plant. A small amount of gaseous nitrogen, oxygen and non condensables separate from the CO2 and are returned to the air separation plant. The liquefied CO2 is then pumped to a pressure typically ranging from 13.8 to 34.5 MPa for sequestration into subterranean oil strata, coal seams, or aquifers.

In FIG. 3, the CO2 is compressed to a pressure of 20.7 MPa for injection of the CO2 into a subterranean formation for sequestration. The 20.7 MPa pressure allows the CO2 to be injected into a permeable subterranean formation located at a depth of approximately 1,000 m or less.

An advantage of the technology of this invention over combined cycle technology is the lower cost to condition CO2 for sequestration of US$9.3/metric ton versus US$28.4/metric ton. This lower CO2 conditioning cost could provide additional revenue for these plants where the CO2 could be used for enhanced oil or coal bed methane recovery, or could be sold as an industrial by product.

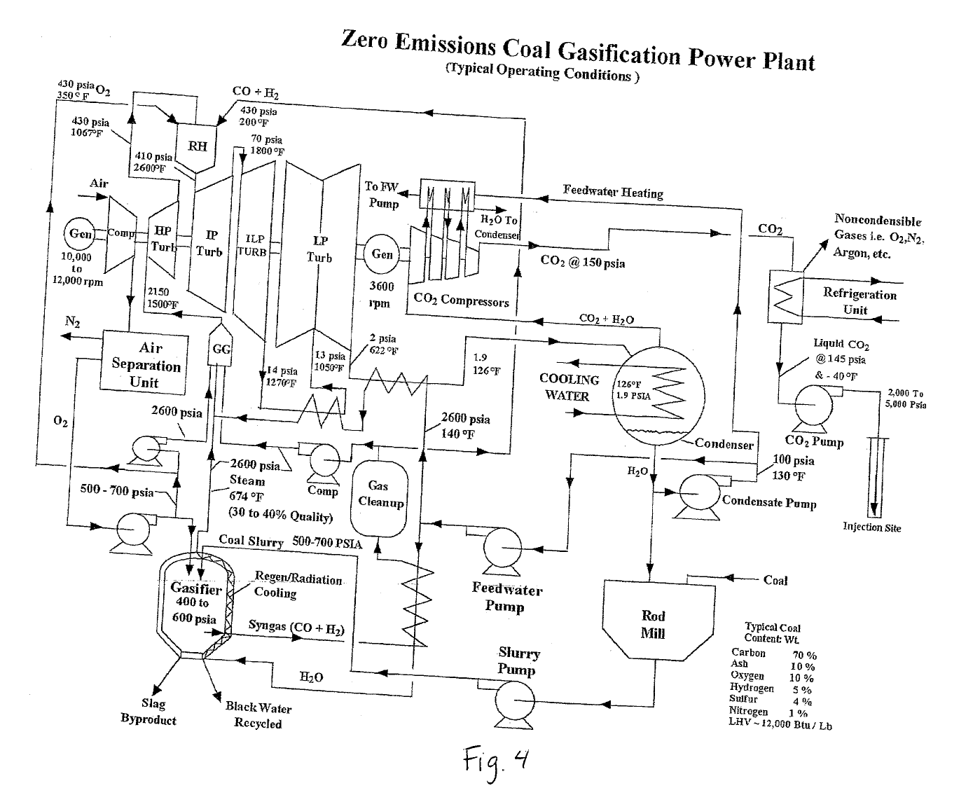

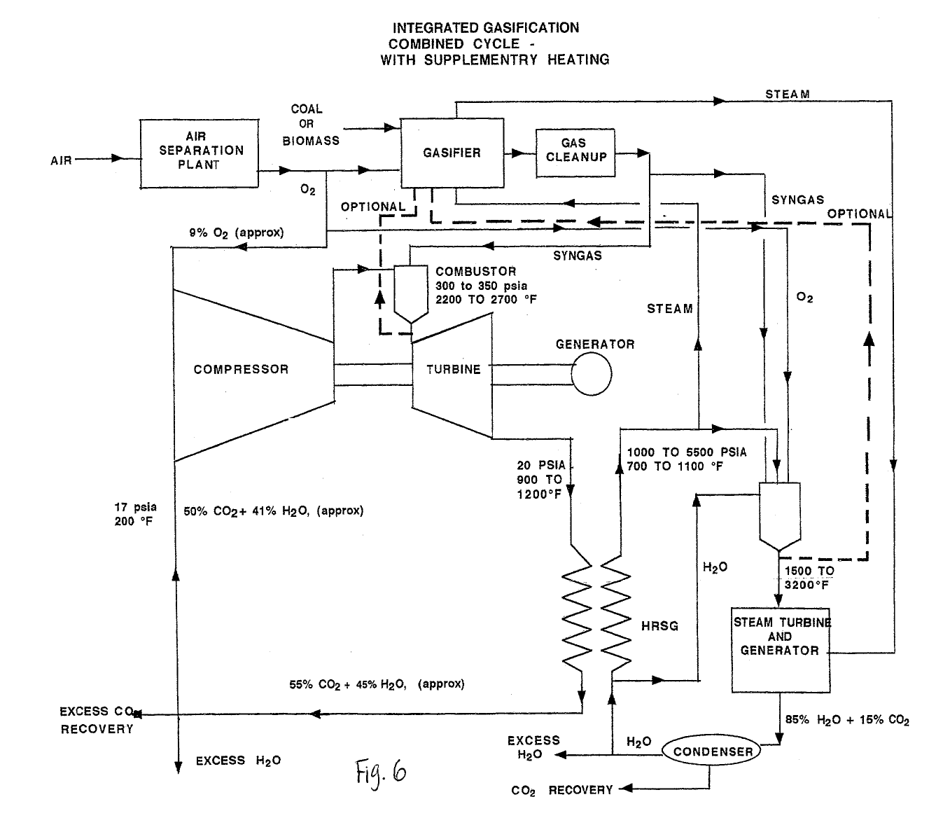

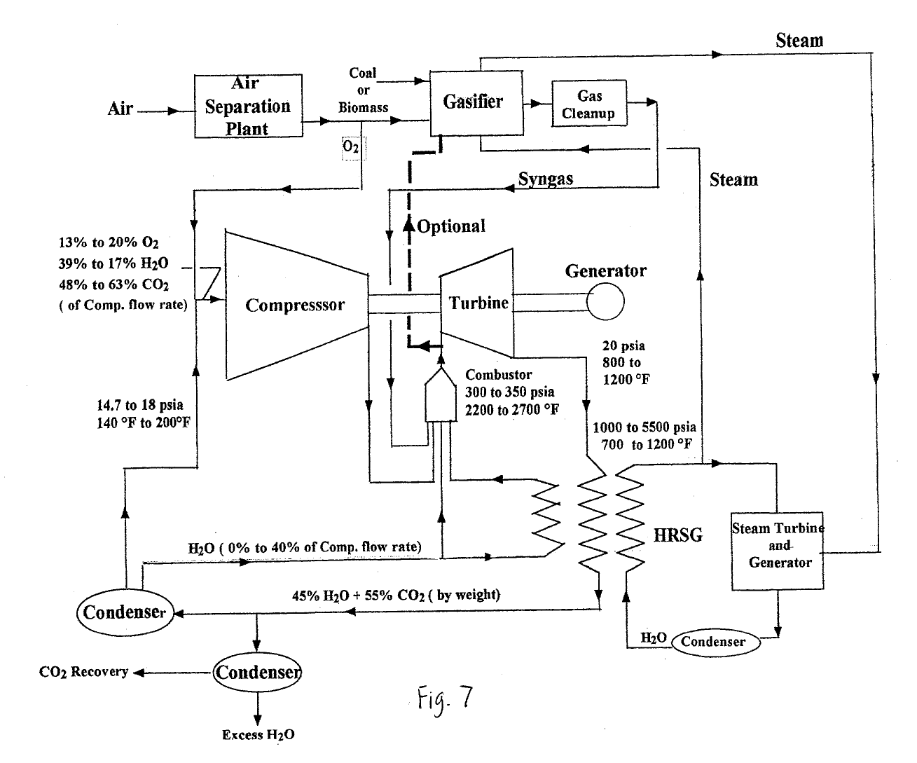

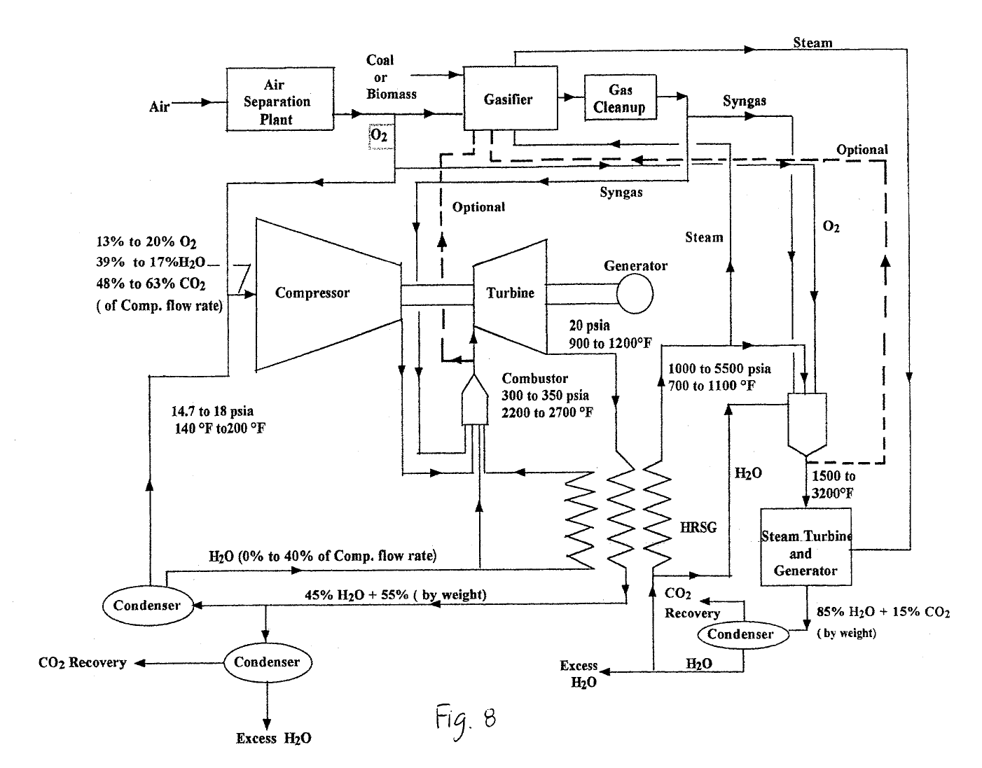

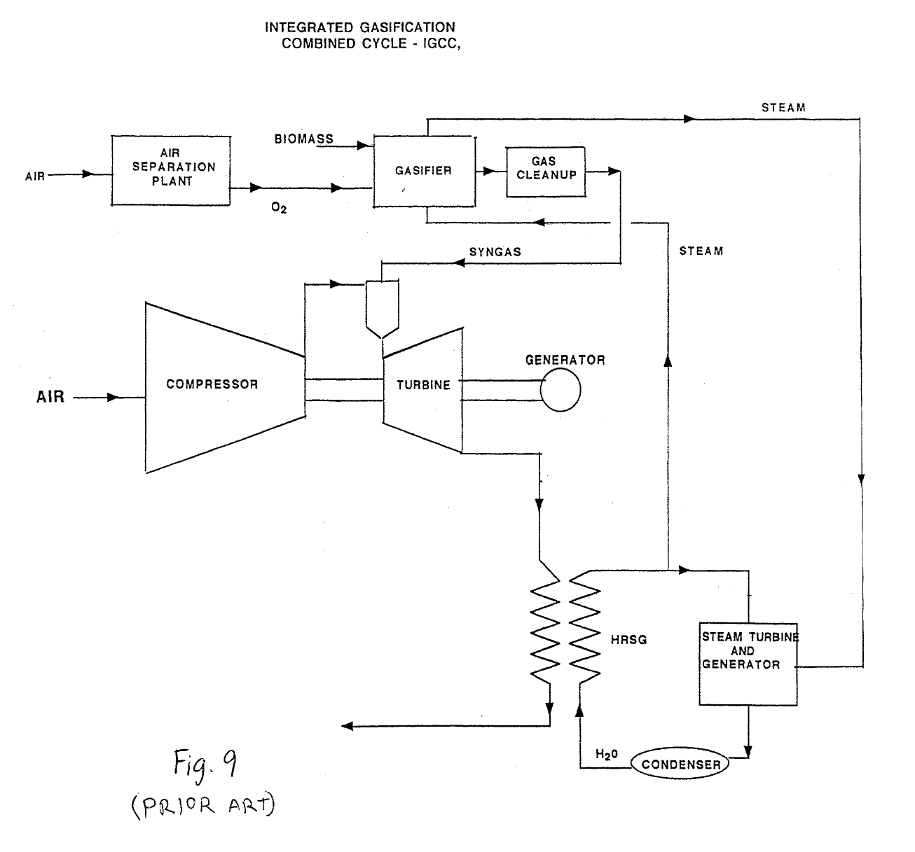

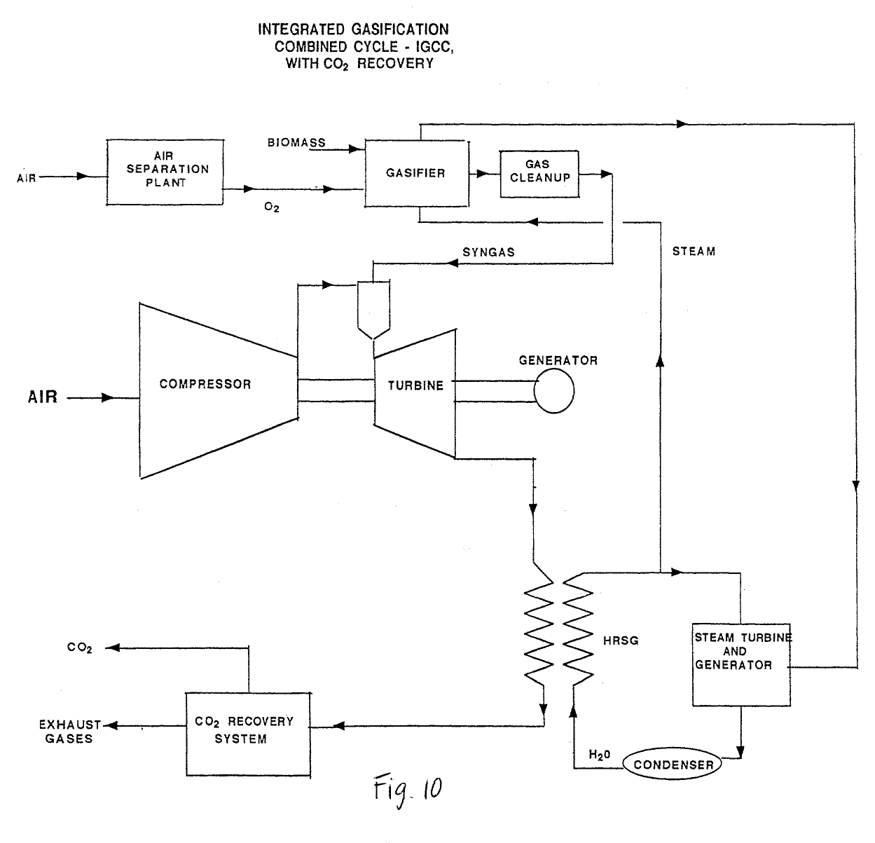

FIGS. 4-12 illustrate multiple schematics depicting alternative non-polluting coal, biomass or other syngas fueled power generation systems. In FIG. 4 a variation on the system of FIG. 3 is shown. This FIG. 4 system uniquely includes four turbines and CO2 compressors for sequestration.

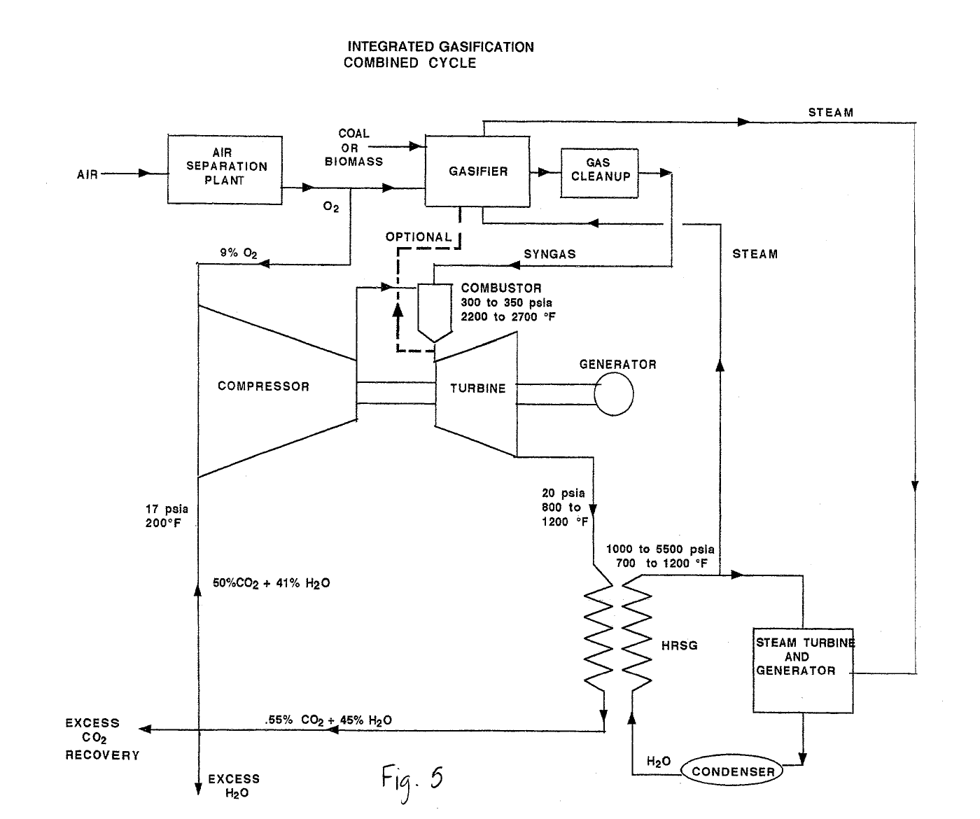

In the alternative embodiment of FIGS. 5-10 use of a Brayton cycle gas turbine powered by a working fluid generated within a combustor fueled by syngas from a gasifier fed with coal or biomass, or other carbon containing fuels is shown. The details of the open or closed Brayton cycle portion of the systems depicted in FIGS. 5-10 can be understood more clearly with reference to U.S. patent application Ser. No. 09/855,237, having a filing date of May 14, 2001, incorporated herein by reference. When the system operates as a combined cycle the bottoming cycle can be configured similar to the systems depicted in FIGS. 1-4 with steam for the steam turbine of the bottoming cycle generated by combustion of syngas produced from coal from a biomass or other carbon containing fuel. Alternatively, the bottoming cycle can be fueled with natural gas or other hydrogen, carbon or hydrocarbon containing fuels.

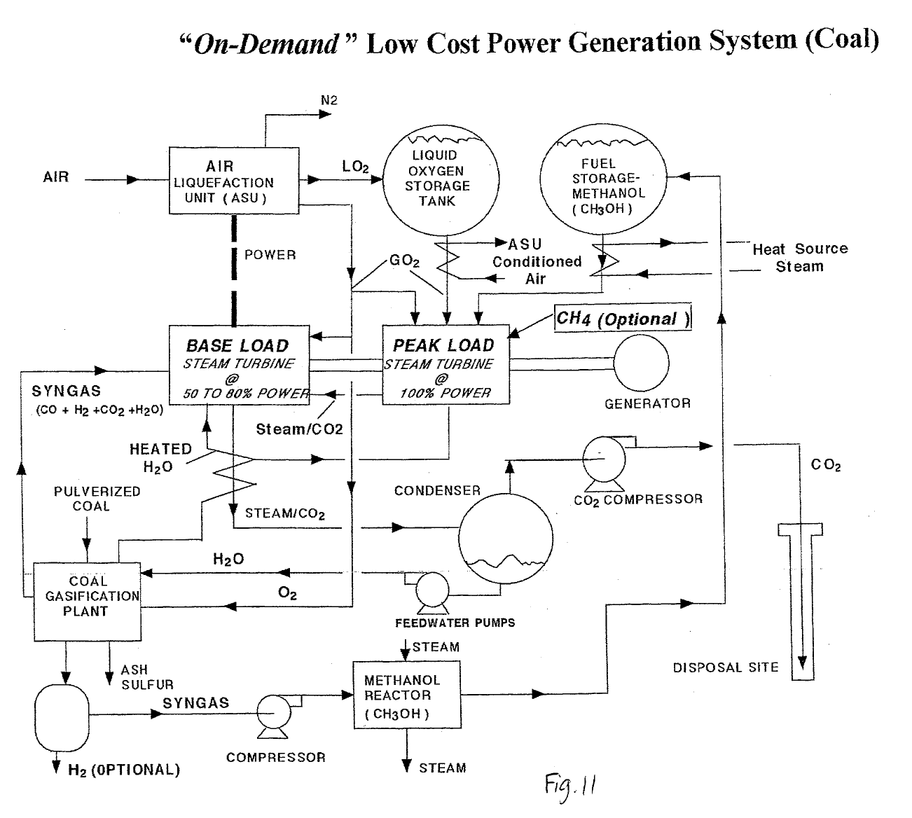

FIG. 11 depicts an alternative embodiment of the systems disclosed in FIGS. 1-10 with one or more of the systems of FIGS. 1-10 utilizable as part of an overall power generation system which is optimized for base load conditions and peak load conditions. Specifically, and as shown in FIG. 11, the air separation unit (ASU), whether an air liquefaction unit or utilizing some other technique for air separation, produces a stream of both gaseous oxygen (GO2) and liquid oxygen (LO2). The liquid oxygen is directed to a liquid oxygen storage tank. The air liquefaction unit is sized to produce more oxygen than is necessary to merely operate the base load power plant in the form of a steam turbine of a Rankine cycle or a turbine of a Brayton cycle. This excess oxygen would leave the air separation unit in the form of liquid oxygen and be directed to the liquid oxygen storage tank.

In periods where peak electricity demand exists, an additional power turbine (either a Rankine cycle steam turbine or turbines, or a Brayton cycle power generation system) would be brought into operation. Liquid oxygen from the liquid oxygen storage tank and potentially additionally gaseous oxygen from the air separation unit would be utilized as the oxidizer for a gas generator in this peak load portion of the overall power generation system. When peak load conditions pass, the peak load turbine would be shut down and the air separation unit would again store excess liquid oxygen.

An additional option of the system of FIG. 11 includes providing a methanol reactor where steam is combined with syngas to produce methanol (CH3OH). This methanol could be directed to a methanol liquid fuel storage structure. This methanol fuel could then be utilized during periods of peak load to power the peak load turbine. Natural gas could additionally be optionally utilized to drive the peak load turbine.

With this system of FIG. 11 an air separation unit and coal gasification plant can be provided which are sized smaller than a maximum power output for which the power generation system is capable. During base load conditions the air separation unit and coal gasification plant are producing excess liquid oxygen and methanol. During periods of peak load the oxygen and fuel beyond that produced by the air separation unit and coal gasification plant are provided by the liquid oxygen storage tank and fuel storage, and optionally a methane or a natural gas source.

The various components of the system of FIG. 11 can be selected from any of the components specifically described in any of the references incorporated into this application by reference, as indicated above. This system also optionally provides for hydrogen gas separation from the system. This hydrogen gas could be sold as an industrial gas or utilized to produce additional power, either by combustion of the hydrogen or by utilizing the hydrogen within a fuel cell.

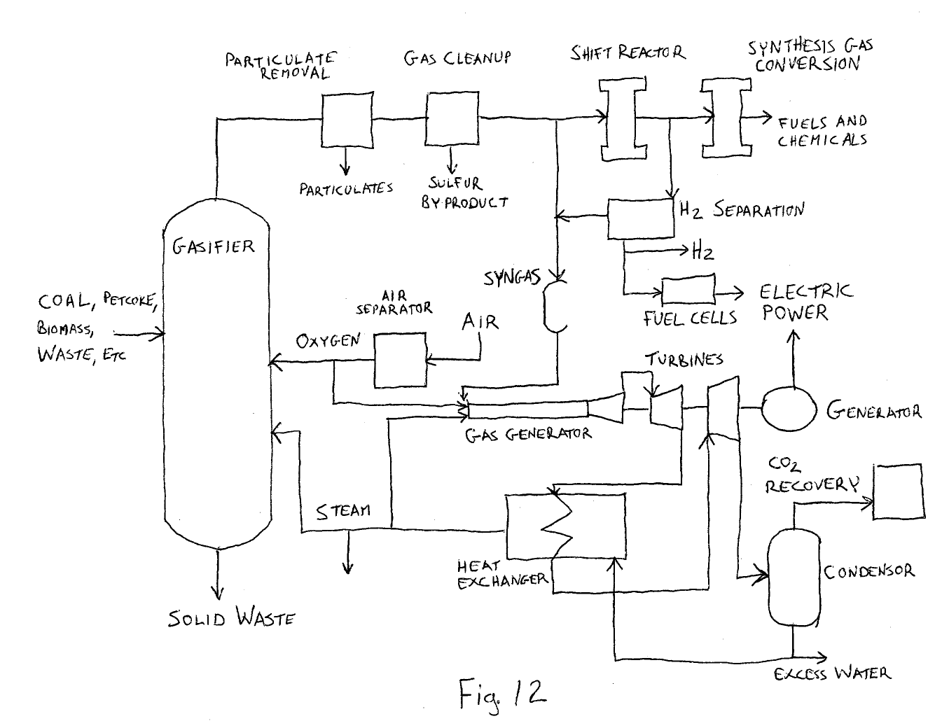

FIG. 12 depicts an additional variation on the coal syngas or other syngas fueled power generation systems described in FIGS. 1-11. Specifically, FIG. 12 illustrates an embodiment where syngas produced by a gasifier fed with coal, petcoke, biomass, waste, etc. is diverted through a shift reactor or through other separation structures to separate hydrogen out of the syngas. This hydrogen can then be released from the system or fed to fuel cells to generate electric power along with the power generated by the turbines fed with steam and carbon dioxide generated within the gas generator.

The system of FIG. 12 provides an overall power generation system in which a carbon or carbon and hydrogen containing fuel is gasified and hydrogen is separated for power generation through hydrogen fuel cells. While the system of FIG. 12 generally depicts a Rankine cycle for the gas generator and turbines, the system of FIG. 12 could similarly utilize a Brayton cycle or combined Rankine and Brayton cycle combustion based power generation subcomponent alongside the fuel cell power generation subcomponent of this system. Specific details of the system of FIG. 12 are further amplified by particular reference to the preferably methane fired power generation system described in U.S. patent application Ser. No. 10/155,932 filed on May 24, 2002 incorporated herein by reference.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1 - A zero-emissions coal fired power generation system, comprising in combination:
a source of air, the air including nitrogen and oxygen;
a source of water;
a source of coal;
an air separator having an inlet coupled to said source of air, a means to separate at least a portion of the nitrogen from the oxygen, an oxygen enriched air outlet, and a nitrogen outlet separate from said oxygen enriched air outlet;
a coal gasifier including a coal inlet coupled to said source of coal, an oxygen inlet coupled to said oxygen enriched air outlet of said air separator, a water inlet coupled to said source of water, and a coal syngas outlet, said gasifier adapted to chemically react the coal from said source of coal with the oxygen from said air separation plant and the water from said source of water to generate coal syngas for delivery to said coal syngas outlet;
a coal syngas combustor, said coal syngas combustor receiving coal syngas from said coal syngas outlet of said gasifier and oxygen from said oxygen enriched air outlet of said air separator, said combustor combusting at least a portion of the coal syngas with at least a portion of the oxygen to produce elevated pressure and elevated temperature combustion products including water and carbon dioxide, said combustor having a discharge for the combustion products;
a combustion product expander located downstream from said discharge of said coal syngas combustor, said expander adapted to output power and having an exhaust for the combustion products;
a combustion products separator downstream from said expander, said separator having a first outlet for combustion products including water and a second combustion product outlet for at least a portion of the carbon dioxide;
a compressor located downstream from said second combustion product outlet of said separator, said compressor compressing the carbon dioxide to above atmospheric pressure; and
a terrestrial formation injection system located downstream from said compressor and upstream from a terrestrial formation beneath the atmosphere, said terrestrial formation capable of holding carbon dioxide therein.

2 - The power generation system of claim 1 wherein a recirculation pathway extends between said first outlet of said separator and said source of water, such that at least a portion of the water in said source of water is provided with water from said first outlet of said separator.

3 - The power generation system of claim 2 wherein said syngas combustor includes a water inlet therein coupled to said source of water.

4 - The power generation system of claim 1 wherein a syngas reheater is located downstream from said exhaust of said combustion product expander, said reheater adapted to elevate a temperature of the combustion products entering said reheater; and
a second combustion product expander downstream from said reheater, said second expander adapted to output power.

5 - The power generation system of claim 1 wherein said air separator includes means to liquefy at least a portion of the air to separate at least a portion of the nitrogen from at least a portion of the oxygen with said air separator including at least one air compressor powered by power outputted from said combustion products expander.

6 - The power generation system of claim 1 wherein said air separator is in the form of an ion transfer membrane separator including at least one air preheater, said air preheater receiving heat from said combustion products downstream from said syngas combustor in heat transfer relationship with the air entering said air separator.

7 - The power generation system of claim 1 wherein said combustion product expander includes at least two turbines with a reheater downstream from a first of said at least two turbines adapted to increase a temperature of said combustion products downstream of a first of said at least two turbines and upstream of the second of said at least two turbines, said turbines adapted to output power from said power generation system.

8 - The power generation system of claim 7 wherein said first outlet of said separator is coupled to a water recirculation pathway extending from said first outlet of said separator to said source of water, said water pathway including at least one feed water heater therein located in heat transfer relationship with the combustion products downstream from said first of at least two turbines and upstream of said separator.

9 - The power generation system of claim 8 wherein said water recirculation pathway includes at least two feed water heaters therein including a first feed water heater in heat transfer relationship with combustion products downstream from said second of said at least two turbines and a second feed water heater located in heat transfer relationship with combustion products downstream from said first turbine of said at least two turbines and upstream of said second turbine of said at least two turbines.

10 - The power generation system of claim 9 wherein said combustion products expander includes at least three turbines including a high pressure turbine, an intermediate pressure turbine and a low pressure turbine with a reheater between said high pressure turbine and said intermediate pressure turbine adapted to increase a temperature of combustion products downstream of said high pressure turbine and upstream of said intermediate pressure turbine, and a second reheater located between said intermediate pressure turbine and said low pressure turbine with said second reheater increasing a temperature of combustion products downstream of said intermediate pressure turbine and upstream of said low pressure turbine; and
wherein said water recirculation pathway includes at least three feed water heaters, each feed water heater in heat transfer relationship with the combustion products downstream from said syngas combustor and upstream of said separator, a first of said at least three feed water heaters located in heat transfer relationship with the combustion products downstream from said low pressure turbine, a second of said at least three feed water heaters located in heat transfer relationship with the combustion products downstream of said intermediate pressure turbine and a third of said at least three feed water heaters located in heat transfer relationship with the combustion products downstream of said high pressure turbine.

11 - A zero emissions syngas fired power generation system, comprising in combination:
a source of air;
a source of water;
a source of syngas, the syngas taken from the group including gasified coal, landfill gas, gasified biomass, gaseous refinery residues, gasified refinery residues, gasified petcoke, gasified waste or combinations thereof;
an air separator having an inlet coupled to said source of air, an oxygen enriched air outlet and a nitrogen outlet separate from said oxygen enriched air outlet, said air separator adapted to separate at least a portion of the nitrogen from the oxygen within said air separator;
a syngas combustor, said syngas combustor receiving syngas from said source of syngas and oxygen from said oxygen enriched air outlet of said air separator, said combustor combusting at least a portion of the syngas with at least a portion of the oxygen to produce elevated pressure and elevated temperature combustion products including water and carbon dioxide, said combustor having a discharge for the combustion products; and
a combustion product expander located downstream from said discharge of said syngas combustor, said expander adapted to output power and having an exhaust for the combustion products.

12 - The power generation system of claim 1 wherein a combustion products separator is located downstream from said expander exhaust, said expander adapted to separate at least a portion of the water from a portion of the carbon dioxide; and
a water recirculation pathway extending between said separator and said source of water, such that at least a portion of the water in said source of water is provided from said separator.

13 - The power generation system of claim 2 wherein said syngas combustor includes a water inlet therein coupled to said source of water.

14 - The power generation system of claim 1 wherein a syngas reheater is provided downstream from said exhaust of said combustion product expander, said reheater adapted to elevate a temperature of the combustion products entering said reheater; and
a second combustion product expander downstream from said reheater, said second expander adapted to output power.

15 - A low or no pollution Brayton cycle syngas power generation system, comprising in combination:
a source of air, the air including nitrogen and oxygen;
a source of water;
a source of syngas fuel, the syngas taken from the group including gasified coal, landfill gas, gasified biomass, gaseous refinery residues, gasified refinery residues, gasified petcoke, gasified waste or combinations thereof;
an air separator having an inlet coupled to said source of air, an oxygen enriched air outlet and a nitrogen outlet separate from said oxygen enriched air outlet, said air separator adapted to separate at least a portion of the nitrogen from the oxygen within said air separator;
said source of syngas fuel including a gasifier having a fuel inlet, an oxygen inlet coupled to said oxygen enriched air outlet of said air separator, a water inlet coupled to said source of water, and a syngas outlet, said gasifier adapted to chemically react the fuel with the oxygen from said air separation plant and the water from said source of water to generate syngas for delivery to said syngas outlet;
a gas compressor having an inlet and an outlet;
a combustor downstream from said compressor outlet, said combustor having a syngas fuel port coupled to said syngas outlet of said gasifier, an oxidizer port coupled to said compressor outlet and an outlet port for combustion products resulting from combustion of the syngas fuel from said gasifier with oxidizer from said compressor;
a turbine downstream from said combustor, said turbine having an input coupled to said combustor outlet port, an output for the combustion products entering said turbine at said input, and a power output;
a return duct downstream from said turbine, said return duct receiving at least a portion of the combustion products passing through said output of said turbine and extending to said inlet of said compressor; and
a gaseous oxygen duct coupled to said oxygen enriched air outlet of said air separator, said gaseous oxygen duct adapted to add oxygen to the combustion products within said return duct for delivery to said compressor inlet.

16 - The system of claim 15 wherein a combustion products divider is located downstream of said turbine output for the combustion products, said divider adapted to divide a portion of the combustion products for removal from the system without return to said compressor, and with a remainder of the combustion products passing to said return duct for return to said compressor inlet.

17 - The system of claim 16 wherein a heat recovery steam generator is located downstream from said turbine, said heat recovery steam generator heating water in heat transfer relationship with the combustion products downstream of said turbine, said heat recovery steam generator generating steam for power generation or other industrial use.

18 - The system of claim 16 wherein said combustion products diverted away from said return duct are directed to a separator, said separator having a water outlet and a carbon dioxide outlet, said carbon dioxide outlet coupled to a compressor and a terrestrial formation injection system located downstream from said compressor and upstream from a terrestrial formation beneath the atmosphere, said terrestrial formation capable of holding carbon dioxide therein.

19 - The system of claim 18 wherein said combustion products separator includes a condenser with said water outlet removing liquid combustion products from said separator and said carbon dioxide outlet removing gaseous combustion products out of said separator.

20 - The system of claim 15 wherein said oxygen duct is adapted to add an amount of oxygen to the combustion products in said return duct which will cause the combination of oxygen and combustion products in the return duct to together enter said compressor as a mixed gas having gas characteristics sufficiently similar to the gas characteristics of air to allow said compressor to be designed for compression of air and be able to effectively compress the mixture of oxygen and combustion products entering said compressor.

21 - A low or no pollution syngas fired power generation system, comprising in combination:
a source of air;
a source of water;
a source of syngas, the syngas taken from the group including gasified coal, landfill gas, gasified biomass, gaseous refinery residues, gasified refinery residues, gasified petcoke, gasified waste or combinations thereof;
an air separator having an inlet coupled to said source of air, an oxygen enriched air outlet and a nitrogen outlet separate from said oxygen enriched air outlet, said air separator adapted to separate at least a portion of the nitrogen from the oxygen within said air separator;
said source of syngas including a gasifier having a fuel inlet, an oxygen inlet coupled to said oxygen enriched air outlet of said air separator, a water inlet coupled to said source of water, and a syngas outlet, said gasifier adapted to chemically react the fuel with the oxygen from said air separation plant and the water from said source of water to generate syngas for delivery to said syngas outlet;
a methanol generator, said methanol generator having a syngas inlet coupled to said syngas outlet of said gasifier, and a steam inlet coupled to said source of water, said methanol generator adapted to generate methanol from syngas and steam, said methanol generator including a methanol outlet coupled to a liquid methanol storage tank;
a liquid oxygen storage tank having an oxygen inlet coupled to said oxygen enriched air outlet of said air separator;
a primary syngas combustor, said primary syngas combustor receiving syngas from said coal syngas outlet of said gasifier and oxygen from said oxygen enriched air outlet of said air separator, said primary syngas combustor combusting at least a portion of the syngas with at least a portion of the oxygen to produce elevated pressure and elevated temperature combustion products including water and carbon dioxide, said combustor having a discharge for said combustion products;
a secondary combustor, said secondary combustor receiving fuel from said liquid methanol storage tank and oxygen from said liquid oxygen storage tank, said secondary combustor adapted to combust the methanol fuel with the oxygen to produce elevated pressure and elevated temperature combustion products including water and carbon dioxide, said combustor having a discharge for said combustion products;
at least one combustion product expansion device located downstream from both said primary combustor and said secondary combustor, said combustion products expansion device adapted to expand said combustion products and output power, said at least one combustion products expansion device adapted to expand combustion products from either said primary combustor alone, said secondary combustor alone or both said primary combustor and said secondary combustor simultaneously; and
a combustion products separator downstream from said at least one combustion product expander, said separator having a first outlet for combustion products including water and a second combustion product outlet for at least a portion of the carbon dioxide, said first outlet coupled to said source of water.

22 - The system of claim 21 wherein a compressor is located downstream from said second combustion product outlet, said compressor compressing said combustion product including carbon dioxide to above atmospheric pressure; and
a terrestrial formation injection system located downstream from said compressor and upstream from a terrestrial formation beneath the atmosphere, said terrestrial formation capable of holding carbon dioxide therein.

23 - The system of claim 21 wherein water from said source of water is provided to said gasifier, said primary combustor and said secondary combustor and exits said primary combustor and said secondary combustor along with the combustion products generated within said primary combustor and said secondary combustor.

24 - The power generation system of claim 23 wherein said gasifier is adapted to produce syngas including hydrogen; and
a hydrogen separator located downstream from said syngas outlet of said gasifier, said hydrogen separator separating at least a portion of gaseous hydrogen from the syngas.

25 - The system of claim 24 wherein said hydrogen discharged from said hydrogen separator is at least partially directed to at least one fuel cell, said fuel cell including an oxygen inlet coupled to said oxygen enriched air outlet of said air separator, and a water outlet for water generated within said at least one fuel cell.

26 - The system of claim 25 wherein said water outlet of said fuel cell is coupled to said source of water for introduction into said syngas combustor.
